(19) United States
(12) Patent Application Publication
(10) Pub. No.: US 2017/0047154 A1
(43) Pub. Date: Feb. 16, 2017

(54) High Capacity Power Transformer Housing With a Noise Shielding Structure

(71) Applicant: Fortune Electric Co., Ltd., Taoyuan City (TW)

(72) Inventors: Chien-Sheng Liu, Taoyuan City (TW); Te-Li Chen, Taoyuan City (TW)

(21) Appl. No.: 14/823,084

(22) Filed: Aug. 11, 2015

(51) Int. Cl. H01F 27/02; H01F 27/33

(52) U.S. Cl. CPC H01F 27/02; H01F 27/33

(57) ABSTRACT

A high capacity power transformer (1) includes a housing (3) having top and bottom ends. A top board (32) extends outwards from four sides of the top end of the housing (3). A bottom board (33) extends outwards from four sides of the bottom end of the housing (3). A frame (4) is connected between each of four sides of the top board (32) and a corresponding one of four sides of the bottom board (33). An outer wallboard (5) envelops and is fixed to each frame (4). A sound absorbing material layer (6) is mounted to an inner face of each outer wallboard (5) facing the housing (3). The sound absorbing material layers (6) are connected to each other and surround four sides of the housing (3). The outer wallboards (5) are connected to each other and surround the four sides of the housing (3).

### BACKGROUND OF THE INVENTION

The present invention relates to a high capacity power transformer housing with a noise shielding structure and, more particularly, to a high capacity power transformer housing surrounded by a noise shielding structure.

A housing of a super high-voltage transformer for transmitting electricity is generally a hollow, closed, parallelepiped placed on the ground. An iron core and windings are placed in an interior of the housing that is filled with a transformer oil (an insulating oil) for cooperating with a cooling system.

During manufacture of the conventional transformer, the housing is subject to a vacuum process. To increase the structural strength of the housing, outwardly protruding reinforcing frames are welded to upper and lower sections of the outer periphery of the housing. The iron core and the windings generate noise when the transformer operates. The resonant noise from the periphery of the housing of the transformer greatly disturb the environment and the workers therearound. The manufacturers and the power companies are troubled by these disadvantages and cannot find a way to effectively solve these disadvantages.

Thus, a need exists for a novel power transformer housing to mitigate and/or obviate the above disadvantages.

### BRIEF SUMMARY OF THE INVENTION

The primary objective and the main function of the present invention is to provide outer wallboards and sound absorbing material layers around a housing of a power transformer, forming a soundproof wall for inhibiting and reducing the resonant noise from the housing of the power transformer and avoiding disturbance to the environment and the workers therearound. Furthermore, the noise shielding structure for the power transformer is easy to manufacture and assemble, reducing the costs.

A high capacity power transformer housing with a noise shielding structure according to the present invention includes a housing having top and bottom ends. A top board extends outwards from four sides of the top end of the housing. A bottom board extends outwards from four sides of the bottom end of the housing. A frame is connected between each of four sides of the top board and a corresponding one of four sides of the bottom board. An outer wallboard envelops and is fixed to each frame. Each outer wallboard includes an inner face facing the housing. A sound absorbing material layer is mounted to the inner face of each outer wallboard. The sound absorbing material layers are connected to each other and surround four sides of the housing. The outer wallboards are connected to each other and surround the four sides of the housing.

The high capacity power transformer housing can further include two reinforcing protrusive frames mounted around the four sides of the housing and located between the top board and the bottom board. Each sound absorbing material layer extends between one of the frames and one of the two reinforcing protrusive frames. Each sound absorbing material layer is filled in an interior of one of the frames.

Each sound absorbing material layer can be filled between one of the four sides of the housing and one of the outer wallboards.

Each sound absorbing material layer can be sound absorbing cotton.

The housing can further include a sealed space below the bottom end of the housing. The sealed space receives sound absorbing cotton.

The high capacity power transformer housing can further include a peripheral frame bar mounted along the four sides of each of the top board and the bottom board. Each frame can include a plurality of vertical bars connected between the peripheral frame bars and spaced from each other. Each frame can further include a plurality of horizontal bars spaced from each other and connected between the plurality of vertical bars. The plurality of vertical bars and the plurality of horizontal bars form a plurality of lattices. Each outer wallboard includes a plurality of wallboard units. Each of the plurality of wallboard units is fixed in one of the plurality of lattices.

Each of the plurality of outer wallboards and the plurality of lattices can include a periphery having a plurality of fixing holes. A bolt extends through each of the plurality of fixing holes, fixing each of the plurality of wallboard units in one of the plurality of lattices.

Each of the peripheral frame bars on the top board and the bottom board can include a plurality of fixing plates connected to the vertical bars. A bolt extends through each of the plurality of fixing plates for connection with a corresponding one of the vertical bars.

The present invention will become clearer in light of the following detailed description of illustrative embodiments of this invention described in connection with the drawings.

### DESCRIPTION OF THE DRAWINGS

FIG. 1 is a perspective view of a high capacity power transformer housing according to the present invention.

FIG. 2 is an enlarged view of a circled portion A of FIG. 1.

FIG. 3 is an enlarged view of another circled portion B of FIG. 1.

FIG. 4 is a perspective view illustrating mounting of frames surrounding the housing of FIG. 1.

FIG. 5 is an enlarged view of a circled portion C of FIG. 4.

FIG. 6 is a perspective view illustrating mounting of outer wallboards around the frames of the housing of FIG. 4.

FIG. 7 is an enlarged view of a circled portion D of FIG. 6.

FIG. 8 is a cross sectional view of the high capacity power transformer of FIG. 1.

FIG. 9 is a cross sectional view of the high capacity power transformer of FIG. 4.

FIG. 10 is a cross sectional view similar to FIG. 9, with outer wallboards and sound absorbing layers mounted to the frames of the housing.

FIG. 11 is a cross sectional view similar to FIG. 10, illustrating another arrangement of the sound absorbing layers.

### DETAILED DESCRIPTION OF THE INVENTION

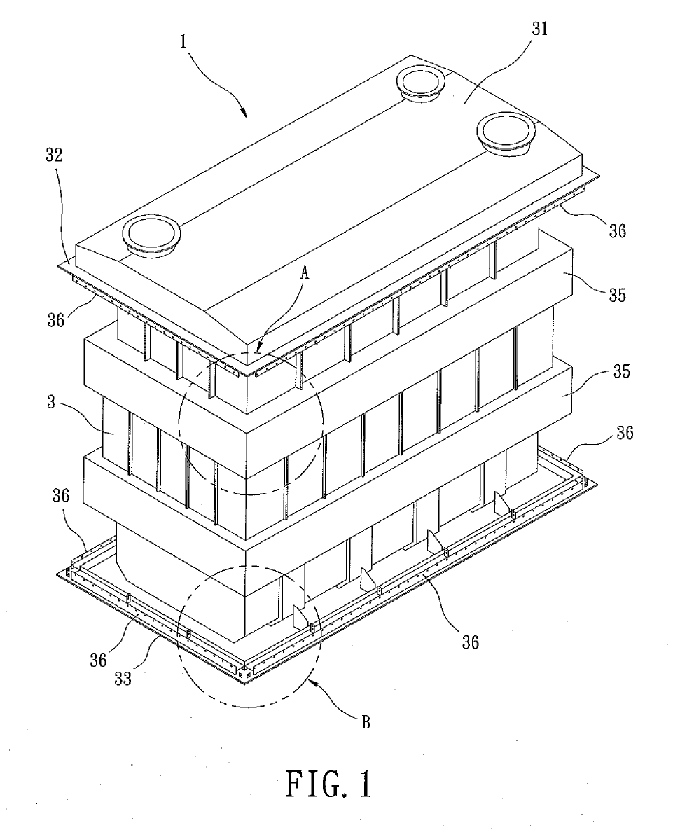

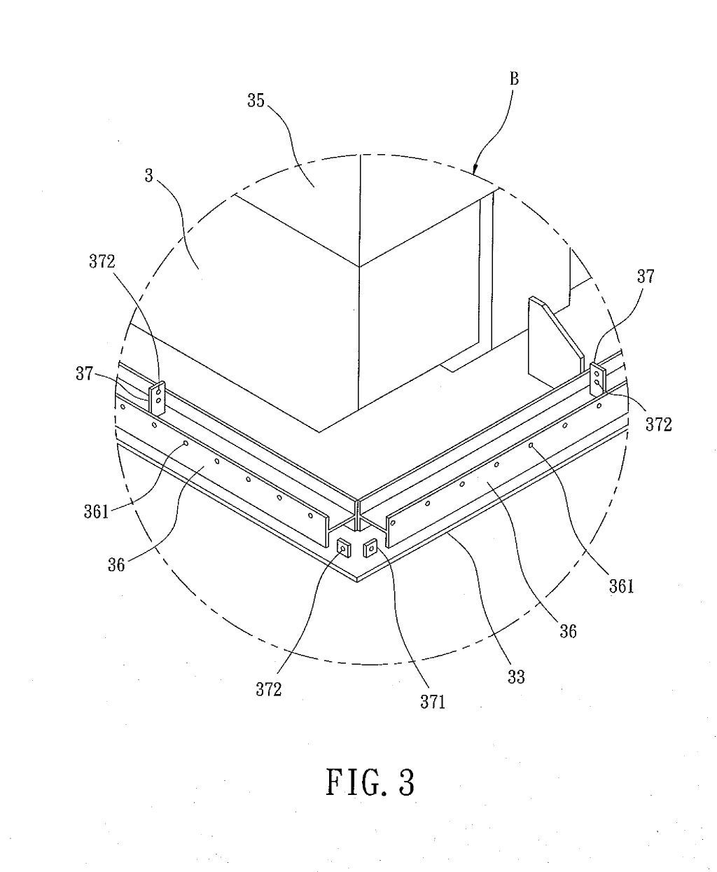

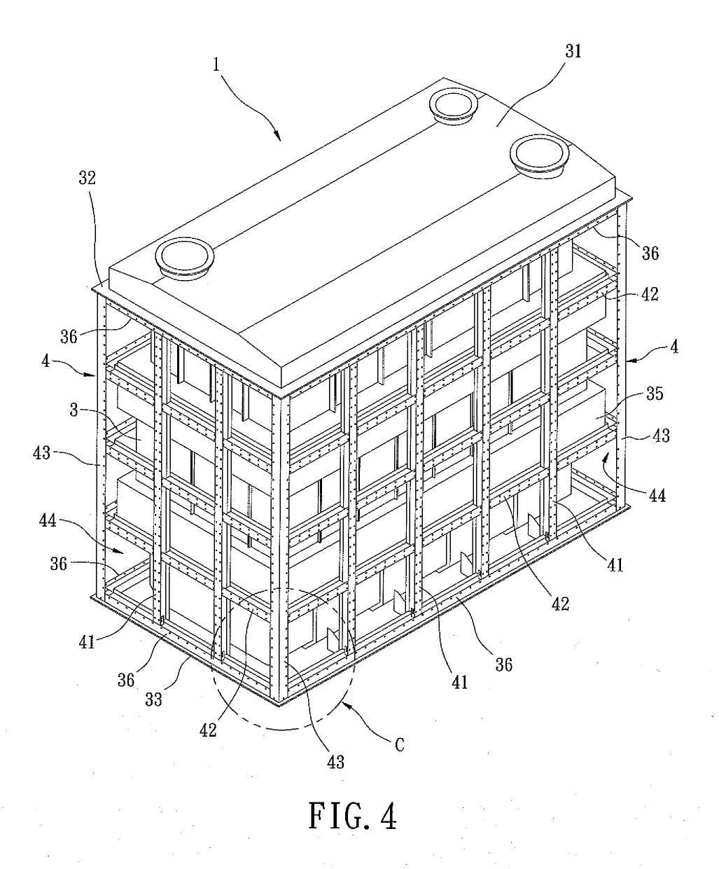

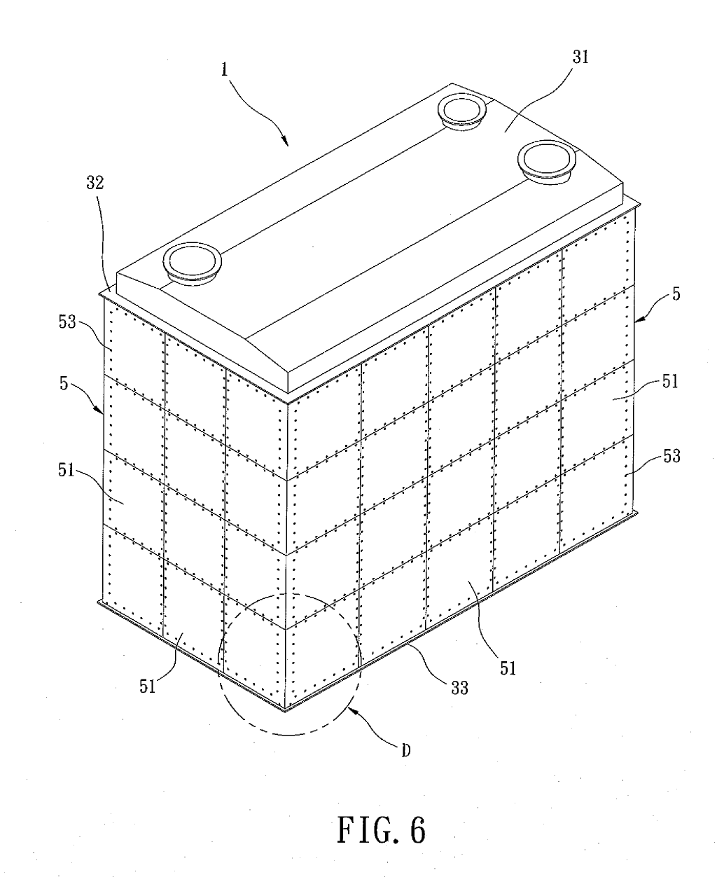

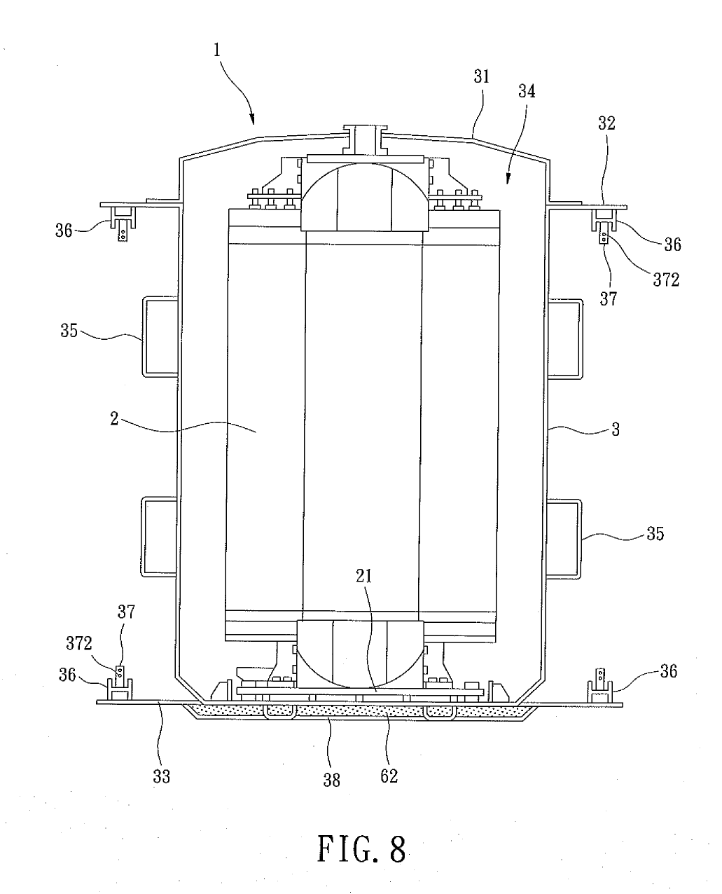

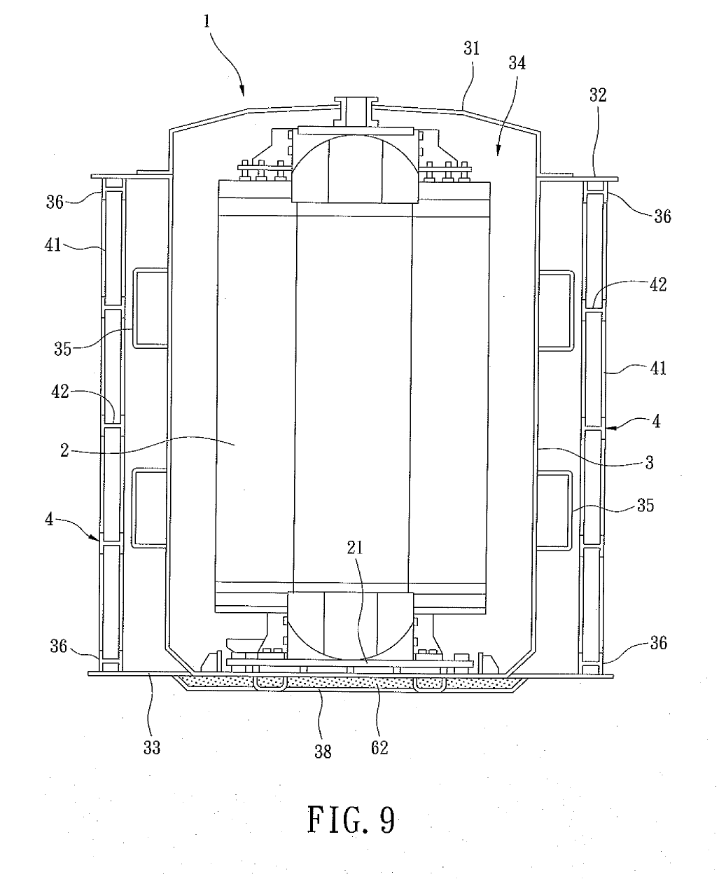

With reference to FIGS. 1-10, a noise shielding structure according to the present invention is suitable for a super high-voltage (high capacity) power transformer 1 for transmitting electricity. As shown in the figures, the high capacity power transformer 1 includes a housing 3 and a housing cover 31 mounted on top of the housing 3. The housing 3 is substantially a sealed parallelepiped placed on the ground. Two continuous reinforcing protrusive frames 35 are welded to upper and lower sections of a periphery of the housing 3. The reinforcing protrusive frames 35 are mounted around the four sides of the housing 3 and are located between the top board 32 and the bottom board 33. An iron core and windings of a transformer core 2 and a fixing frame 21 are mounted in a receiving space 34 in the housing 3. The receiving space 34 is filled with an insulating oil.

Specifically, the noise shielding structure for the housing 3 and the power transformer 1 includes a top board 32 extending outwards from four sides of a top end of the housing 3 and having four sides. A bottom board 33 extends outwards from four sides of a bottom end of the housing 3 and has four sides. A frame 4 is connected between each of the four sides of the top board 32 and a corresponding one of the four sides of the bottom board 33 and is spaced from the housing 3. An outer wallboard 5 envelops and is fixed to each frame 4. Each outer wallboard 5 includes an inner face facing the housing 3. A sound absorbing material layer 6 is mounted to the inner face of each outer wallboard 5. The housing 3 further includes a sealed space 38 below the bottom end of the housing 3, and the sealed space 38 receives sound absorbing cotton 62.

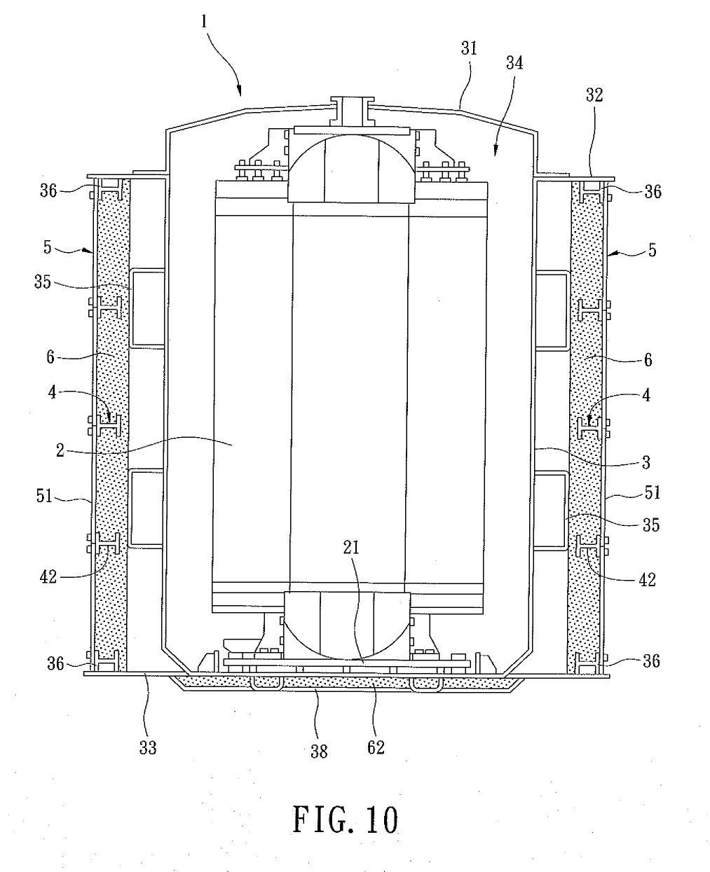

In the power transformer 1 according to the present invention, the sound absorbing material layers 6 are connected to each other and surround four sides of the housing 3, and the outer wallboards 5 are connected to each other and surround the four sides of the housing 3. Thus, each sound absorbing material layer 6 extends between one of the frames 4 and one of the reinforcing protrusive frames 35 (FIG. 10). Each sound absorbing material layer 6 can be sound absorbing cotton. Each sound absorbing material layer 6 is filled in an interior of one of the frames 4 to form a soundproof wall for inhibiting and reducing the resonant noise from the housing 3 of the power transformer 1, avoiding disturbance to the environment and the workers therearound. Furthermore, the noise shielding structure for the power transformer 1 is easy to manufacture and assemble, reducing the costs.

A peripheral frame bar 36 is mounted along the four sides of each of the top board 32 and the bottom board 33 on the housing 3. Each frame 4 includes a plurality of vertical bars 41 connected between the peripheral frame bars 36 and spaced from each other. Each frame 4 further includes a plurality of horizontal bars 42 spaced from each other and connected between the vertical bars 41. The vertical bars 41 and the horizontal bars 42 are positioned by a plurality of angled bars 43 and form a plurality of lattices 44. Each outer wallboard 5 includes a plurality of wallboard units 51. Each wallboard unit 51 is fixed in one of the lattices 44.

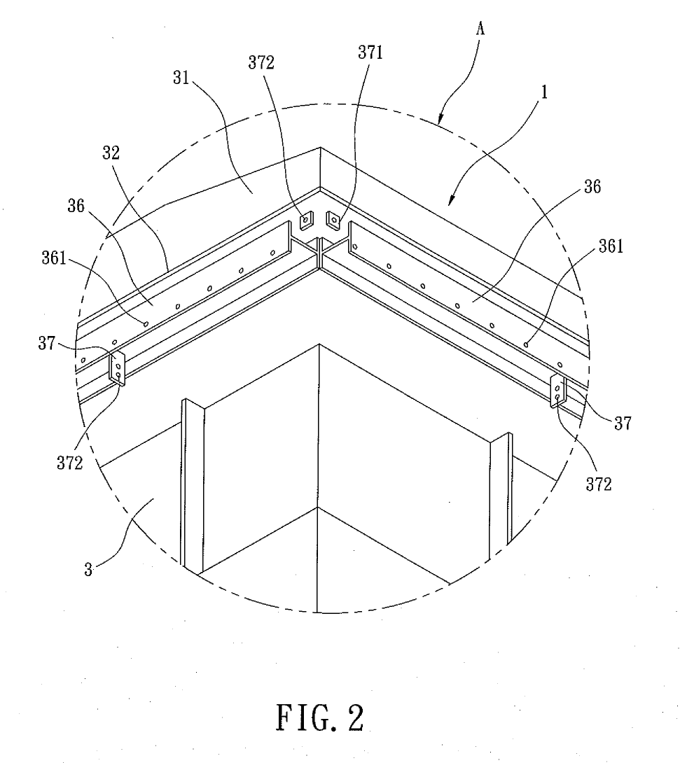

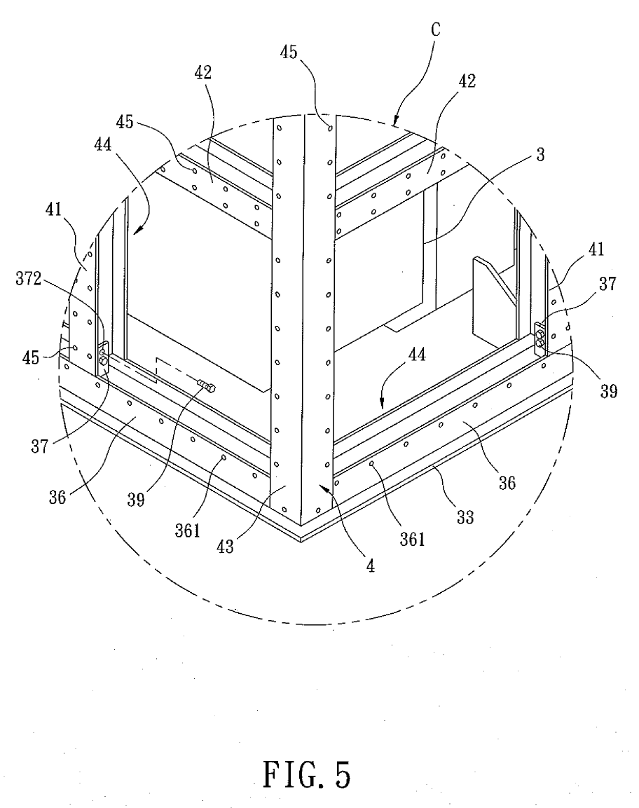

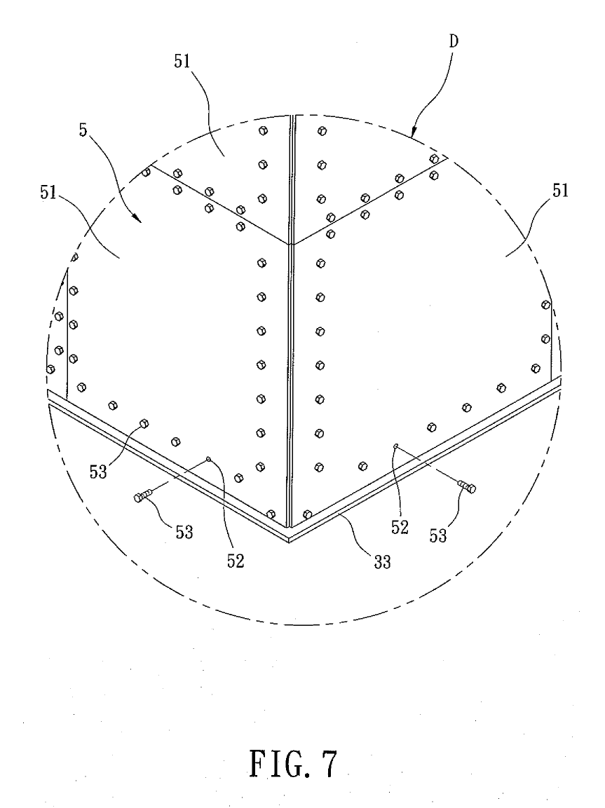

With reference to FIGS. 2, 3, 5, 8, and 9, each of the peripheral frame bars 36 on the top board 32 and the bottom board 33 includes a plurality of fixing plates 37, 371 connected to the vertical bars 41. A bolt 39 extends through each fixing plate 37, 371 for connection with a corresponding one of the vertical bars 41 and a corresponding one of the angled bars 43. With reference to FIGS. 5 and 7, each of the outer wallboards 51 and the lattices 44 includes a periphery having a plurality of fixing holes 361, 45, 52. A bolt 53 extends through each fixing hole 361, 45, 52, fixing each wallboard unit 51 in one of the lattices 44.

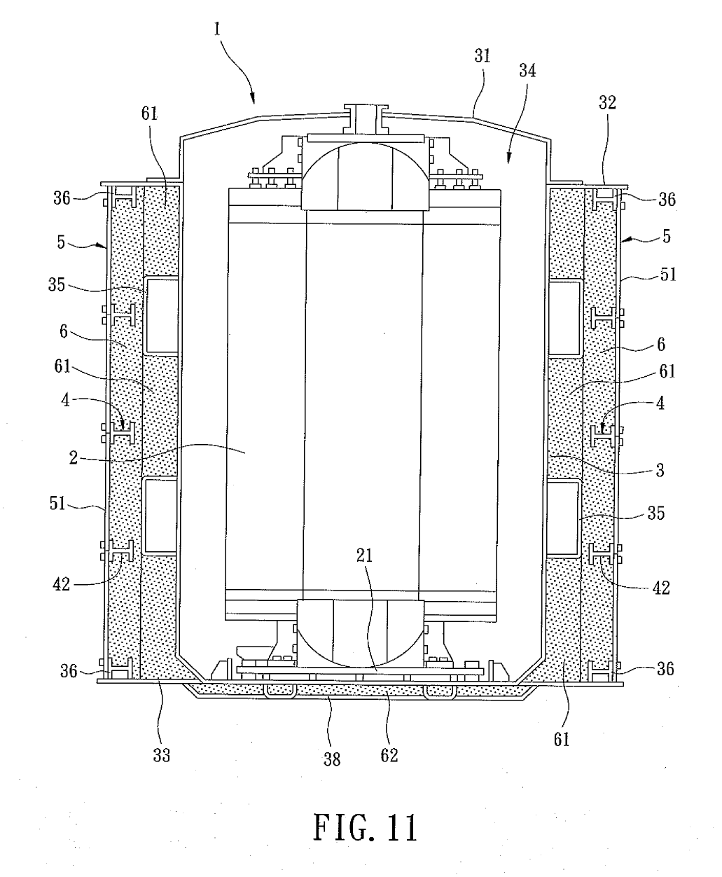

With reference to FIG. 11, the sound absorbing material layers 6 are connected to each other and surround four sides of the housing 3, and the outer wallboards 5 are connected to each other and surround the four sides of the housing 3. Thus, each sound absorbing material layer 6 extends between one of the frames 4 and one of the reinforcing protrusive frames 35. Furthermore, each sound absorbing material layer 6, 61 is filled between one of the four sides of the housing 3 and one of the outer wallboards 5 to form a soundproof wall for inhibiting and reducing the resonant noise from the housing 3 of the power transformer 1, avoiding disturbance to the environment and the workers therearound. Furthermore, the noise shielding structure for the power transmission transformer 1 is easy to manufacture and assemble, reducing the costs.

Although specific embodiments have been illustrated and described, numerous modifications and variations are still possible without departing from the scope of the invention. The scope of the invention is limited by the accompanying claims.

1. A high capacity power transformer housing with a noise shielding structure, comprising:
a housing including top and bottom ends, with each of the top and bottom ends of the housing including four sides, with two reinforcing protrusive frames mounted around the four sides of the housing, with a top board extending outwards from the four sides of the top end of the housing and having four sides, with a bottom board extending outwards from the four sides of the bottom end of the housing and having four sides, with the housing further including a sealed space below the bottom end of the housing and isolated from an outside of the housing, with the sealed space receiving sound absorbing cotton, with a frame connected between each of the four sides of the top board and a corresponding one of the four sides of the bottom board, with an outer wallboard enveloping and fixed to each frame, with each outer wallboard including an inner face facing the housing, with a sound absorbing material layer mounted to the inner face of each outer wallboard, with each sound absorbing material layer extending between one of the frames and one of the two reinforcing protrusive frames, with each sound absorbing material layer filled in an interior of one of the frames, with the sound absorbing material layers connected to each other and surrounding four sides of the housing, with the outer wallboards connected to each other and surrounding the four sides of the housing, with a peripheral frame bar mounted along the four sides of each of the top board and the bottom board, with each frame including a plurality of vertical bars connected between the peripheral frame bars and spaced from each other, with each frame further including a plurality of horizontal bars spaced from each other and connected between the plurality of vertical bars, with the plurality of vertical bars and the plurality of horizontal bars forming a plurality of lattices, with each outer wallboard including a plurality of wallboard units, with each of the plurality of wallboard units fixed in one of the plurality of lattices, with each of the plurality of outer wallboards and the plurality of lattices including a periphery having a plurality of fixing holes, with a plurality of first bolts respectively extending through the plurality of fixing holes, fixing each of the plurality of wallboard units in one of the plurality of lattices, with each of the peripheral frame bars on the top board and the bottom board including a plurality of fixing plates connected to the plurality of vertical bars, and with a plurality of second bolts extending through the plurality of fixing plates for connection with the plurality of vertical bars.

2. (canceled)

3. The high capacity power transformer housing with a noise shielding structure as claimed in claim 1, wherein each sound absorbing material layer is filled between one of the four sides of the housing and one of the outer wallboards.

4. The high capacity power transformer housing with a noise shielding structure as claimed in claim 3, wherein each sound absorbing material layer is sound absorbing cotton.

5-8. (canceled)
